(19) United States
(12) Patent Application Publication
(10) Pub. No.: US 2013/0275257 A1
(43) Pub. Date: Oct. 17, 2013

(54) INTERACTIVE IMAGE CAPTURE, MARKETING AND DISTRIBUTION

(71) Applicant: Clifford R. DAVID, Windermere, FL (US)

(72) Inventor: Clifford R. DAVID, Windermere, FL (US)

(21) Appl. No.: 13/914,533

(22) Filed: Jun. 10, 2013

Related U.S. Application Data
(63) Continuation-in-part of application No. 12/772,275, filed on May 3, 2010, now Pat. No. 8,463,654.
Application No. 12/772,275 is a continuation-in-part of application No. 13/116,487, filed on May 26, 2011.
Application No. 13/116,487 is a continuation of application No. 11/691,583, filed on Mar. 27, 2007, now Pat. No. 7,966,223.
Application No. 11/691,583 is a continuation-in-part of application No. 11/279,642, filed on Apr. 13, 2006, now Pat. No. 7,881,968.
Application No. 11/279,642 is a continuation-in-part of application No. 13/299,679, filed on Nov. 18, 2011.
Application No. 13/299,679 is a continuation-in-part of application No. 11/854,605, filed on Sep. 13, 2007, now Pat. No. 8,260,674.
Application No. 11/854,605 is a continuation-in-part of application No. 11/691,583, filed on Mar. 27, 2007, now Pat. No. 7,966,223.
Application No. 11/691,583 is a continuation-in-part of application No. 11/279,642, filed on Apr. 13, 2006, now Pat. No. 7,881,968.
Application No. 11/279,642 is a continuation-in-part of application No. 13/694,299, filed on Nov. 16, 2012.
(60) Provisional application No. 61/174,515, filed on May 1, 2009.
(60) Provisional application No. 61/293,035, filed on Jan. 7, 2010.
(60) Provisional application No. 60/671,928, filed on Apr. 15, 2005.
(60) Provisional application No. 61/415,026, filed on Nov. 18, 2010.

(51) Int. Cl. G06Q 30/06

(52) U.S. Cl. CPC G06Q 30/0621
USPC 705/26.5

(57) ABSTRACT

Systems and methods for capturing digital images of a customer in a defined location, such as a museum, a garden, a zoo, a religious institution, a theme park, or any other venue where imaging is possible and practical, or in a defined time period, such as a trip or vacation. The systems and methods can be essentially fully automated, using automated cameras and essentially only electronic communications between a customer and a computerized central facility, or can include a human representative or contractor for some of the operations. The souvenir can include other customer-related elements, such as “stock” images, composited images that include the customer or customer-related people or objects, and text and sound.

### REFERENCE TO RELATED APPLICATIONS

This patent application is a continuation-in-part (CIP) of:
(1) Application Ser. No. 12/772,275 filed May 3, 2010 and scheduled to issue as U.S. Pat. No. 8,463,654 on Jun. 11, 2013, which claims the benefit of provisional applications 61/174,515 filed May 1, 2009 and 61/293,035 filed Jan. 7, 2010;
(2) Application Ser. No. 13/116,487 filed May 26, 2011, which is allowed, which is a continuation of Ser. No. 11/691,583 filed Mar. 27, 2007 and now U.S. Pat. No. 7,966,223, issued Jun. 21, 2011 which is a CIP of Ser. No. 11/279,642 filed Apr. 13, 2006 and now U.S. Pat. No. 7,881,968, issued Feb. 1, 2011, which claims the benefit of provisional application 60/671,928 filed Apr. 15, 2005;
(3) Application Ser. No. 13/299,679 filed Nov. 18, 2011, which claims the benefit of provisional application No. 61/415,026 filed Nov. 18, 2010, which is a CIP of Ser. No. 11/854,605 filed Sep. 13, 2007 and now U.S. Pat. No. 8,260,674, issued Sep. 4, 2012, which itself is a continuation-in-part of Ser. No. 11/691,583 filed Mar. 27, 2007 and now U.S. Pat. No. 7,966,223, issued Jun. 21, 2011, which itself is a continuation-in-part of application Ser. No. 11/279,642 filed Apr. 13, 2006 and now U.S. Pat. No. 7,881,968, issued Feb. 1, 2011, which claims the benefit of provisional application 60/671,928 filed Apr. 15, 2005;
(4) Application Ser. No. 13/594,299 filed Aug. 24, 2012 and claiming the benefit of provisional application 61/526,823 filed Aug. 24, 2011.

This application incorporates by reference the entire content of said utility and provisional applications.

### FIELD

This patent specification related generally to systems and methods that involve interactive contact between customers and a central system, which contact may or may not involve human intermediaries, and leads to creating and distributing to the customers or their designees material such as professional quality images of the customers and other scenes, image portfolios, souvenir albums that may also include other content such as text and audio, and other customized visual and audio material that involves the customers or memorializes a customer experience.

### BACKGROUND

Personal digital cameras are widely available and used but may not be the best choice for occasions such as when a professional quality image is desired, or when the person would like an image that includes her or him or a group that includes the person, or when an image should be taken from an otherwise inaccessible angle or the customer is involved in an activity that does not allow use of a camera, or when a customer would like a portfolio or album that includes other material as well that may not be readily available to that person, or would like a book or other souvenir item that includes professional quality images of the person and perhaps other scenes and possibly text and audio. And, there can be a wide variety of circumstances when images taken by professionals are more suitable, as typical at social events, races, theme parks, museums, libraries, etc.

The sale of photographs taken by a photographer of a customer in, for example, a theme park, cruise, hotel, resort, or other event where there are large volumes of people present is known in the art. This approach has inherent inefficiencies, in that the photographer typically prints many more photographs than are ultimately sold, and the sale is dependent upon the customer's viewing and agreeing to purchase the photograph displayed after the event, thereby losing momentum caused by the excitement of the moment.

An additional issue with known systems is that images from certain vantage points, and including objects at a site being visited by the customer, which may comprise, for example, still or video images, are typically not possible or practical when taken by a photographer at a defined location within the site. Thus achieving viable perspectives to capture an image at a site from an optimal vantage point may be impossible for the customer.

Another issue with the known approach is that some sites do not permit photography at all, or may not permit flash photography, owing to security and/or photo-damage concerns. Such prohibitions can prevent the customer from capturing desired images that can comprise priceless memories.

Further, a customer may desire a photograph to be taken at a time when a photographer is not in the vicinity.

Another particular difficulty with photography in general is that there is no universally practical availability of good quality photograph then the photographer him/herself can be in the picture, nor of that person with a group. Personal camera equipment is typically not sufficiently sophisticated to produce a good product, and extra equipment, such as tripods and other accessories must be hauled along to accomplish self-photos. In the realm of videography, there is no practical way to film oneself when the camera is moving. Further, the technical skill is typically lacking, and professional quality photographs or videos taken by amateurs are rare.

Therefore, it would be desirable to provide systems and methods for more efficiently capturing and delivering photographic and/or video images and possibly related audio to a customer. It would also be desirable to provide systems and methods wherein the customer him/herself can be a subject of the image, especially in locations where amateur images are unavailable or impractical. It would be additionally desirable to provide systems and methods for efficiently culling a collection of many images to select a desirable subset and for distributing a collection of images captured at a site.

### SUMMARY OF THE DISCLOSURE

This patent specification describes systems and methods for capturing digital images of a customer or customer-related scenes in a defined location, such as a museum, a garden or pat, a zoo, a religious institution, a theme park, a cruise ship, a resort, a hotel, or any venue in connection with which mementos may be desired that include customer-related images and possibly sounds. The systems and methods provide a customer with a pictorial souvenir of a visit to the site that may not be possible or practical otherwise. The souvenir can include other elements, such as “stock” images, images or sounds that may or may not include the customer but are related to the customer experience that is memorialized in the souvenir album, descriptive verbiage or other indicia, and other material.

In general terms, for which there are variations and specifics discussed below, the systems and methods described in this patent specification establish a customer identification and link it with a computerized central system, and specifically with a customer folder that will contain, or already contains, images and possibly sounds related to the customer experience in or about the relevant venue. The professional quality images related to the customer that the system and methods take automatically or through human representatives, and any sounds related to the customer, go to that folder. The systems and methods take at least some of the images and sounds at the customers specific request, and at the place and time the customer specifically requests, thereby allowing the customer to determine where and when to pose for images and to record sounds. The systems and methods can afford the customer an opportunity to preview and edit the results, possibly iteratively, and to select results for inclusion in a professional quality album that the system creates and provides to the customer, with appropriate compensation arrangements for the central facility from the customer and possibly advertisers, and compensation for any individuals employed by the system or acting as independent contractors. As explained below, some examples use automated cameras and electronic contact with the customer and any human representative, contractor, or advertiser, and some use to some degrees human intermediaries between the customer and the central facility. Also as explained below, there is a variety of ways in which the customers identity can be established and linked with the customer file in the central facility, some of which involve cards, or electronic devices, or similar identification aids given to the customer and some of which involve no such special aids but use the customer's smart phone or similar device to create the pertinent customer ID, to exchange information with the customer during the process, and even to deliver the final product, or one version of that product, to the customer, and to arrange for compensation. The customer ID and the link to the customer folder may be established without any aid that the customer carries, e.g., by using facial recognition technology or some other biometric process, or by the customer entering pertinent information into the system in some other way such as by using a keyboard linked to the central facility or by scanning or broadcasting information from a credit card or some other item that the customer already has.

One example where the new systems and methods are particularly suitable is using wide-angle, high resolution cameras at sites such as stadiums, and venues or events where crowds congregate, such as Times Square or a Marathon race, a theme park, a park such as Central Park in New York, N.Y., and the like. Using a personal device such as a smart phone or a special purpose device, the customer can request images of scenes that involve the customer or are otherwise customer-related. The customer location and images and portions thereof that involve the customer or customer-related scenes are identified at a computerized central facility using a seat number that the customer can provide through her/his personal device, or other technology such as GPS or other electronic tracking, or face recognition and tracking. The customer device can record related audio using the personal device or another device, and the audio can be edited and integrated with images in an album, video clip, or other souvenir material. Through interactive control involving the customer device, the customer can request images and the time when the images are taken (e.g., when posing as desired, alone or with a group), request related images (e.g., of a playing field or another scene), control the acquisition of related sound, receive proof images and sound from the computerized central facility, and select some for an album. The computerized central facility processes the customer requests and selections, controls the automated cameras, edits images and sound, assembles an electronic folder or portfolio, arranges for payment and delivery of results, and delivers results to the customer or a customer designee electronically or as a physical object such as a hard copy or media such as optical discs and flash drives.

Another example is creating a visual souvenir is applying the systems and methods described in this patent specification to a travel venue such as an airliner, a ship, or a train. The visual souvenir can include images of the customer taken under customer control on-board with automated cameras and coordinated with other images and with sound such as images of scenes associated with the customer's location and taken by other automated cameras or provided from stock.

Yet another example is a dedicated facility for automatically taking images and possibly recording related sound under customer control and without a need for professional attendants at sites and events such as weddings, charity functions, and other social or religious or other events. The facility includes automated cameras and lighting and possibly audio recording, which the customers activate and control though dedicated equipment or through personal devices such as smart phones. The facility can include large screens that show the scene so customers can arrange and pose for a capture of a still or video image, and can show the captured images so that the customers can select all or only some for an album. Alternatively, proof images and sound can be sent to the customers' personal devices for selection. The facility is automated to assemble the customer selected images and sound, and possibly other customer-related images and sounds into an album, deliver the results to the customers as described above, and arrange payment.

Yet another example is use in venues such as museums, libraries, and similar facilities. Applying the new systems and methods in such venues can involve customer control over when and where images are taken with automated cameras and lighting, using personal devices such as smart phones or interface devices provided through the venue such as buttons or portable devices or built-in touch screens or keyboards. In addition to customer images, the computerized central facility can include in a customer album material such as images of art or other objects, text and audio that the customer has requested or the central facility has offered to the customer. Upon interactive customer selection and approval, the central facility assembles and delivers albums to the customers as described above.

An alternative application of the new systems and methods involves participation by human representatives who can initiate contact with the customers, take some or all of the customer-related images, and help in the customers' interaction with the computerized central facility for viewing proofs, selecting material for albums, and arrangements for payment and delivery of product. The alternative can apply to any number of venues where one human representative can take images at a given location and others can take images at other locations, or the same human representative can move to different places in the venue or between venues. After initial contact with a customer, the human representative can establish a relationship between the customer identity and images that will be taken for that customer. For example, the representative can hand a ticket with a number and/or some other indicia such as bar code to the customer and can take a photo of that ticket or scan the ticket with an optical or magnetic reader, thereby entering the customer ID in the representative's camera or associated device and/or transmitting it to the central facility. As an alternative, an electronic connection can be established wirelessly between a customer device such as a smart phone and equipment carried by the representative and/or located at the central facility and a hand-shaking exchange can take place over that connection that associates the customer's ID with an electronic folder or portfolio of images that will be taken of or for the customer. The representative then takes images that the customer requests or agrees to, and stores them in his/her camera or associated equipment and/or sends them to the central facility for storage in a manner that associates them with the customer ID. The customer can see proof images on (i) a customer device such as a smart phone to which the representative or the central facility transmits them electronically, (ii) on the representative's camera or other equipment, (iii) on screen(s) located at or near the place(s) where the images were taken, or (iv) through some other process or equipment. Through the representative's equipment or through other equipment, the customer can select some of the images for inclusion in an album and can edit some or request editing such as cropping, darkening or lightening, etc. After possibly repeated interaction, if any, the system assembles an electronic folder or portfolio of the images, and possibly adds other images and other material such as text and sound. After further customer review, if desired and provided, a final product is assembled in the form of an album or other personalized item that may be delivered to the customer or the customer's designee in electronic form through an electronic transmission and/or in other ways, such as a hard copy or an electronic storage medium.

In the example of using the system in New York's Central Park, the proof images may be shown at kiosks that are at strategic locations such as park exits or at or near famous sites such as Bethesda Fountain or the Band Shell. The kiosks can be permanent structures or mobile carts, and can include both facilities for showing and editing/selecting images and facilities for generating the final product such as high-quality printers and binders that can produce a personalized album for a customer and/or an album on an optical or other storage medium. Payment can be arranged with the representative, e.g., with a credit card read by a reader that the representative carries, with the kiosk, or wirelessly through a customer device such as a smart phone, all involving transfer of the pertinent information to the central computerized facility and back to the customer for confirmation.

When human representatives are involved, they can be employees of an organization operating the system described in this patent specification, or they can be independent contractors who are provided with software that enables the operations described above. This software can run on camera equipment that the contractor carries, provided it has the requisite capabilities, or on separate but associated equipment such as a tablet computer or a sufficiently capable smart phone. In each case the equipment and software enable two-way transmission of pertinent images and information between the contractor and the central facility.

One issue with showing proof images to customers so they can select/edit images is that the images should be of good quality to serve their function and yet the customer should still have an incentive to replace them with the final, paid product that the system creates. To this end, the system can provide a disincentive to keeping the proof images in preference to ordering and paying for a final product. Many ways are contemplated for this purpose in the system and method of this patent specification. For example, the proof images provided to a customer device such as a smart phone, tablet or computer can be “vanishing” images that fade away after a preset time and/or according to some other parameter such as number of viewings. The proof images in electronic form can be provided with marks such as writing or some other indicia that are always shown or show from time to time, and they can be provided with associated measures that prevent storing them in device memory and transmitting them from the customer device. Any of the known and future means for preventing or making it more difficult for the customer to print, store, or re-transmit some or all of the proof images, or use the proof images for other than the intended purpose, are contemplated for use in the systems and methods of this patent specification.

These and other features and aspects of the new system and method are illustrated in the drawings briefly described below and from the more detailed description of preferred embodiments that follows. The drawing are solely for the purpose of illustration and description; they are not to scale and do not show every feature or detail, and are not intended as a definition of the limits of the claimed inventions. Features, components, elements, and steps that are illustrated in one figure or are described in one example or embodiment of the new systems and methods can be used together with and in combination with features, components, elements, and steps that are illustrated in another figure(s) or are described in other example(s) or embodiment(s).

### BRIEF DESCRIPTION OF THE DRAWINGS

FIG. 1 is a system schematic of an example of an image capture system for use in a defined location.

FIGS. 2A-2B form a flowchart of exemplary methods of capturing an image in a defined location.

FIG. 3 is a system schematic of another example of an image capture system.

FIGS. 4A-4D form a flowchart of another exemplary method of capturing an image in a defined location.

FIG. 5 is a system schematic of a further example of an image capture system for use in a defined time period.

FIGS. 6A-6B form a flowchart of exemplary methods of capturing an image in a defined time period.

FIG. 7 is a flowchart illustrating features and steps of a system and method for providing customized, customer-controlled albums.

### DETAILED DESCRIPTION OF PREFERRED EMBODIMENTS

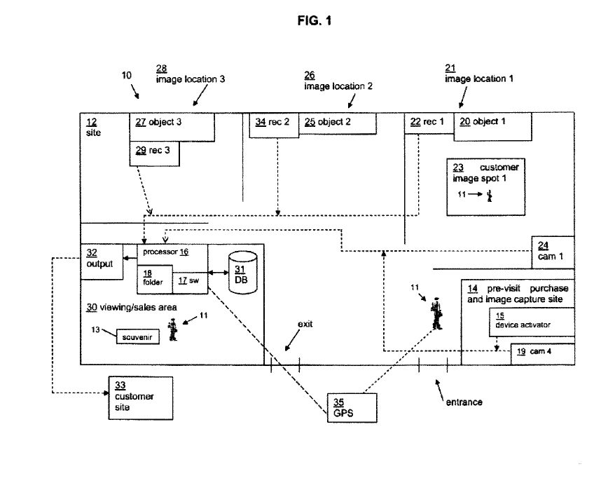

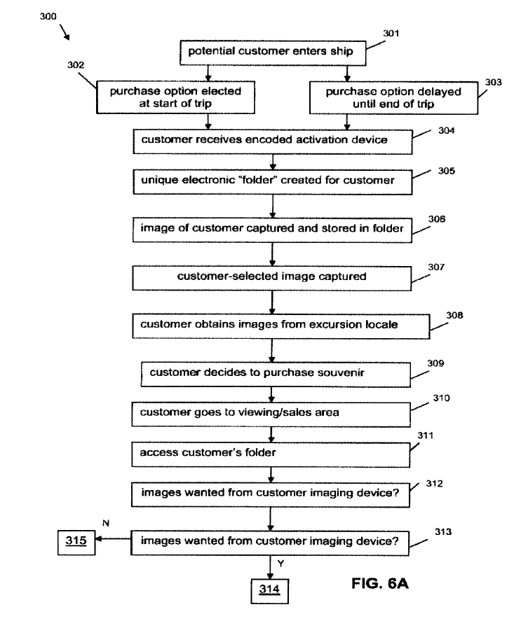

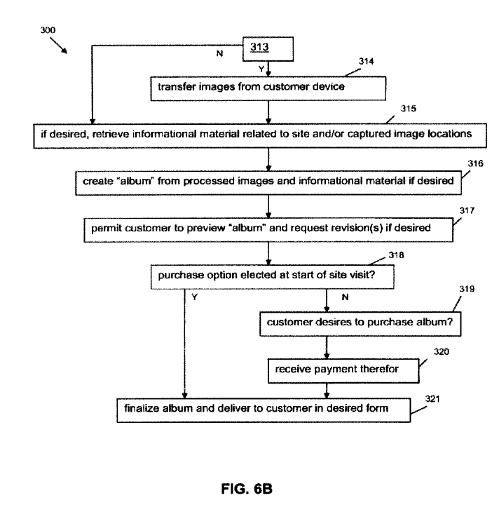

A description of preferred embodiments of the present invention will now be presented with reference to FIGS. 1-6B.

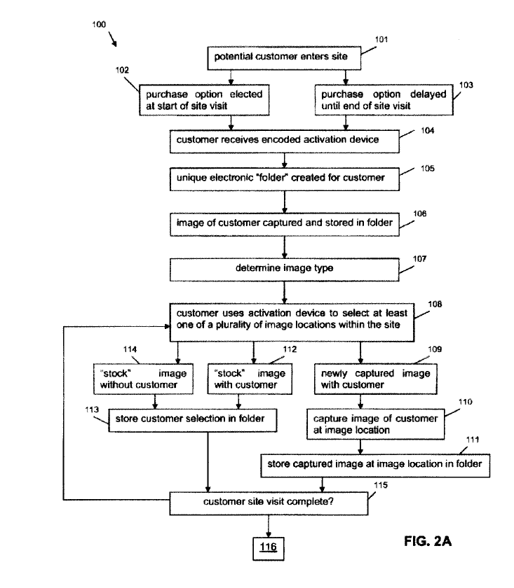

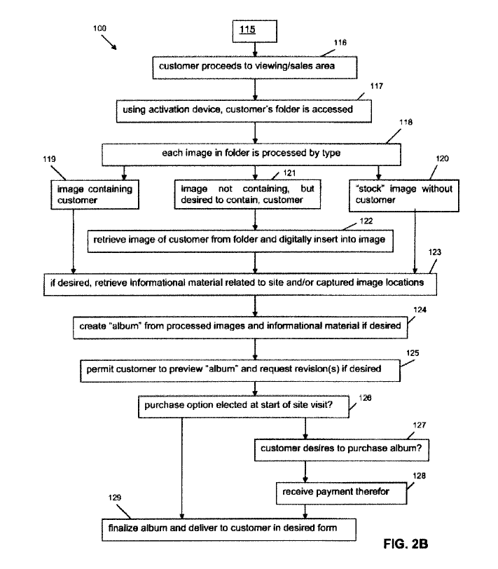

A system 10 (FIG. 1) and method 100 (FIGS. 2A,2B) capture a digital image of a customer 11 in a defined location or venue. The system 10 and method 100 are preferably for use in a defined location, venue, or site 12, such as, but not intended to be limited to, a museum, a garden, a zoo, a religious institution, a theme park, a resort, a hotel, a stadium, a sports event, an airplane, a ship, a train, a public space, or any other site or venue where images can be taken. The system 10 and method 100 provide a customer with a professional quality pictorial souvenir 13 of a visit to the site 12. It will be understood by one of skill in the art that the words picture, image, camera, and photograph are not intended to be limited to a particular construction or equipment, and that still and moving images and recording devices can be contemplated thereby, and may include other media such as sound.

In a particular embodiment, a potential customer 11 enters a site 12 that has been outfitted with components for creating a pictorial memento 13 of the visit (block 101). The opportunity to purchase this souvenir 13 can be offered to the customer 11 upon entering the site 12, for example, at a pre-visit purchase and image capture site 14, an offer that can be accepted (block 102) or rejected (block 103) by the customer 11. In either case, the customer 11 can be given an encoded activation device 15 (block 104), which can comprise, for example, a card with a readable magnetic stripe such as known in the art. This device can also comprise the customer's cell phone or a remote control device, or any other such device capable of transmitting a signal.

A protocol is established for communication between the activation device 15 and a processor 16, which has software 17 for creating a folder 18 specific to the customer 11 (block 105). In one embodiment, an initial image of the customer 11 can be captured by an intake camera 19 and stored in the folder (block 106), for example, using “green screen” technology so that the customer's image can be embedded subsequently in other images if desired.

As the customer 11 is touring the site 12, s/he may desire to capture an image of and/or with an object at the site 12 (block 107) There are several ways in which this may be accomplished, although these examples are not intended to be limiting. In one case, the customer 11 may desire to be imaged with a first object 20 at a first image location 21 (block 109). The customer 11 uses the activation device 15 to contact a first receiver 22 (block 108), which is in signal communication with the processor 16. A first customer image spot 23 is indicated near the first object 20, and a first image location camera 24 images the customer 11 (block 110) and transmits the image to the processor 16, which stores the image in the customer's folder 18 (block 111).

Another option includes the customer 11 desiring his/her image to be inserted into a scene with a second object 25, for example, at a second location 26 (block 112). Again, the customer 11 uses the activation device 15 to contact a second receiver 34, which communicates the customer's order to the processor 16, which stores the order in the folder 18 (block 113).

A further option includes the customer 11 desiring a reproduction of an image of a third object 27 at a third image location 28, without the customer image therein (block 114). The customer 11 uses the activation device 15 to contact a third receiver 29, which communicates this order to the processor 16, which in turn stores the order in the folder 18 (block 113).

In some embodiments it may be desirable that the camera 24 be placed so as to capture an object that can move, for example, a ride in an amusement park, a performer, or an animal in a zoo. In this case, the camera 24 may be mounted for movement on a platform 36 that can be placed in signal communication with the activation device 15. This configuration would permit the customer 11 to control movement of camera 24 to capture a desired object within range of the camera's panning ability.

It will be understood by one of skill in the art that other methods of communication and customer identification can be used. For example, instead of having an activation device 15, one or more forms of biometric identification could inform the system as to the customers identity, such as, but not intended to be limited to, fingerprint, iris scan, and facial recognition. Additional data can be collected to increase the chance that the system will recognize a particular customer, such as searching for a particular item of clothing or color worn by the customer, imaging more than one customer at a time (for example, a companion), or imaging a numerical identifier worn by the customer.

In addition, the location of the customer can be determined “passively,” by GPS 35 sensing of the customers activation device 15, or by some other electronic way to identify the position of device 15 based on emissions from the device or some other detectable parameter of the device. This option also permits the system to sense the customers location and associate the location with data stored in a database 31 in signal communication with the processor 16.

In another embodiment, the image location 21,26,28 could have signage indicating a telephone number for the customer to call. The system could then use the call 10 from the customers telephone to associate the customer's folder 18 with the location 21,26,28. Yet another way is to have the customer supply the pertinent location, e.g., a seat number, through a cell phone call or some other communication to the central facility.

This process can be repeated until the customers visit is complete (block 115), at which time s/he can proceed to the viewing/sales area 30 (block 116) if desired. Using the activation device 15, the customers folder 18 is accessed (block 117). Each image and order in the folder 18 is processed according to type (block 118). An image containing a customer 11 is retrieved from the folder 18 (block 119), and a “stock” image without the customer 11 is retrieved from the database 31 (block 120). For those images wherein the customer 11 wishes to be inserted (block 121), the associated “stock” image is retrieved from the database 31, and the customers image, as taken in step 106, is inserted thereinto digitally to form composited images, for example by using technology similar to that of Adobe's Photoshop (block 122).

The customer 11 can also have the option to have the souvenir 13 enhanced with material stored in the database 31, such as informational textual material and/or additional images (block 123). For example, in a museum, didactic material relating to a particular objet d'art could be inserted. A complete “album” can then be digitally created (block 124), and the customer 11 can preview the album on an output device 32 and request revisions as desired (block 125). If sound is desired, the customer can help in recording sound in the device 15 that can be, for example, the customers smart phone, and send it to the central facility for incorporation into a digital album that can be stored electronically or in computer-readable media. If the souvenir 13 had not been purchased at the start of the visit (block 124), and if the customer 11 wishes to purchase the souvenir 13 (block 127), payment is received (block 128).

The final souvenir 13 is then delivered to the customer 11 in one or more forms (block 129). For example, the souvenir 13 can take the form of a physical, printed album, which could be printed and bound on site. Alternatively, the souvenir 13 can take the form of a digital record, for example, stored on media. Further, the souvenir 13 can take the form of a digital record transmitted to the customer 11 at a desired site 33. The digital media and record can contain both still and moving images and sound, as desired, and alternatively or in addition can be sent to a customers designee such as a friend or relative, an office, and a printing shop.

The final souvenir 13 can comprise multiple forms and components as desired. For example, an album could include material suitable for entertaining children, such as a coloring book, which would serve the purpose of being both amusing and educational.

Further, some of the cost of producing the souvenir 13 can be defrayed by including advertising. The advertising could be “stock,” that is, directly related to the site itself or the surrounding area (local restaurants, shops, etc.). Alternatively, the advertising could be targeted to the customer from data gleaned on customer demographics and customer preferences, as determined by the software 17 from the material selected by the customer. For example, if the customer is in a museum with dissimilar items, but the customer gravitates to a particular type of display (e.g., medieval art, Civil War, etc.), correlations can be made as to vendors and merchandise that might appeal to the customer. Such preferences can then be used, not only to select advertising to appear in the souvenir 13, but also for subsequent marketing opportunities to the customer via, for example, email or direct mail marketing campaigns.

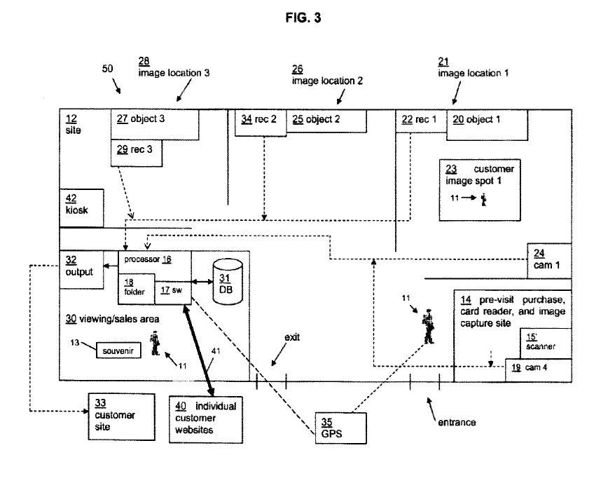

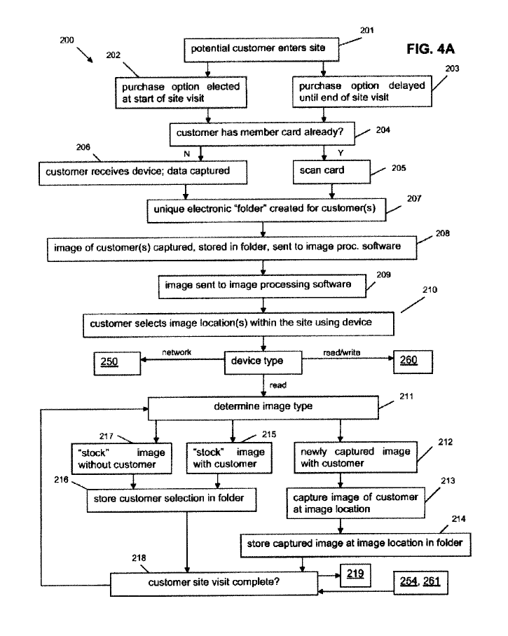

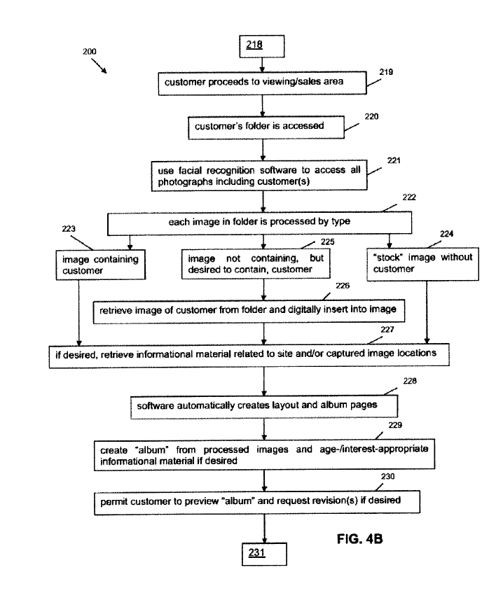

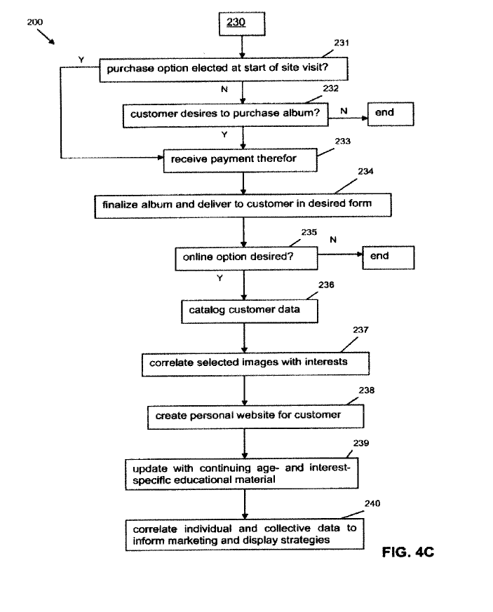

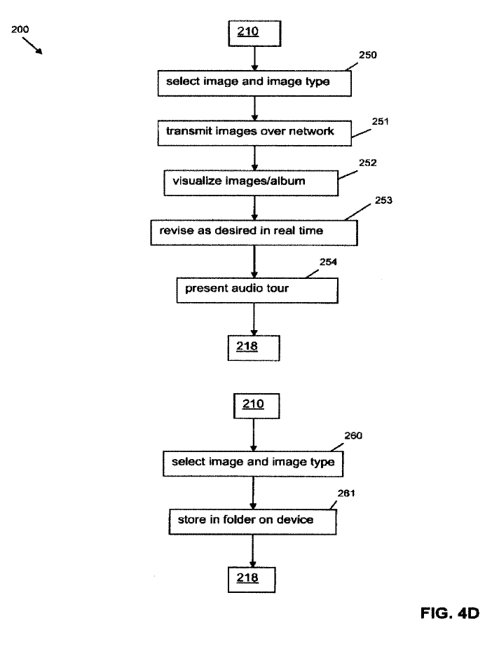

In another embodiment a system 50 (FIG. 3) for use in a defined location and a method 200 (FIGS. 4A-4O) are provided that can embrace additional features. FIG. 3 is a system schematic that incorporates similar elements as in FIG. 1 discussed above, with common numerals indicative of common elements.

In the defined-location embodiment 50,200, a potential customer 11 enters the site 12 that has a membership option (block 201). The opportunity to purchase a souvenir 13 can be offered to the customer 11 upon entering the site 12, as above, an offer that can be accepted (block 202) or rejected (block 203) by the customer 11. The customer 11 is queried as to whether s/he is already a member (block 204). If so, the customer's membership card or other device is read, for example, by scanning 15′ (block 205); otherwise, the customer receives a device such as a scannable card, and the customer's pertinent data are captured (block 206), which can include a photograph/image in some embodiments, and also can include data such as age, which will be used as a basis upon which to include such material as informational narrative. The word “card” is being used herein without limitation, and one of skill in the art will appreciate that any device that can communicate in such a way as to identify the user is intended to be subsumed herein. For example, a read-only or a read/write card could be used, with a magnetic strip such as known in the art. Further “smart” devices such as cellular telephones and media playing devices can also be used instead of or in addition to another type of card to identify the customer and serve to establish a link between the customer and the computerized central facility.

The software 17 creates a folder 18 specific to the customer 11 (block 207) linked to the customer ID. An image of the customer 11, which can comprise an image of the customer with those accompanying him/her, can be captured by the intake camera 19 and stored in the folder (block 208) and also sent to image-processing software (block 209).

As the customer 11 is touring the site 12, s/he may indicate a desire to capture an image of and/or with an object at the site 12 with the device (block 210). The selection and communication procedure can then proceed in at least two ways, which is determined by the type of device being used (block 210a) and the site configuration (block 211). For example, for a device that does not have “write” capabilities, the following steps are taken.

There are several ways in which the device may be used, although these examples are not intended to be limiting. In one case, the customer 11 may desire to be imaged with a first object 20 at a first image location 21 (block 212). The customer 11 uses his/her device to contact a first receiver 22, which is in signal communication with the processor 16. A first customer image spot 23 is indicated near the first object 20, which can be accomplished with visual means such as known in the art. Visual and/or audio means can also be used to “count down” until the shot is taken. A first image location camera 24 images the customer 11 (block 213) and transmits the image to the processor 16, which stores the image in the customer's folder 18 (block 214).

Another option includes the customer 11 desiring his/her image to be inserted into a scene with a second object 25, for example, at a second location 26 (block 215). Again, the customer 11 uses the device to contact a second receiver 34, which communicates the customer's order to the processor 16, which stores the order in the folder 18 (block 216).

A further option includes the customer 11 desiring a reproduction of an image of a third object 27 at a third image location 28, without the customer image therein (block 217). The customer 11 uses the device to contact a third receiver 29, which communicates this order to the processor 16, which in turn stores the order in the folder 18 (block 216).

In some large installations, particularly those that can become crowded, it may be difficult to approach certain popular objects. In such cases, a multi-purpose kiosk 42 having interactivity, via, for example, a touch screen, could be provided wherein a plurality of images of objects in the installation could be displayed, from which the user could select one or more images for inclusion in his/her folder. Such a kiosk 42 could also be used to view the customer's folder in progress.

Returning to block 210, in some cases a device may be used that is in signal communication with the processor 16 operating at or for the central facility. An image is selected as above in blocks 211-217 (block 250). In addition, in such a case the software 17 can be used to transmit images over a network (block 251) so that the customer 11 can visualize the images as they could appear in a finished souvenir product (block 252), and thereby modify selections and captured images in “real time” if desired, which can include re-taking the image (block 253). Also, if desired, such a device can be used to present an audio and/or visual tour (block 254) through the site 12. This device could also be used in other ways known in the art, especially as such devices evolve, such as providing information on using the system 50, instructions on where to stand to have an image taken, how far along the customer is on the tour, etc. These examples are not intended to be limiting, and one of skill in the art will appreciate that such devices can be used In a myriad of ways interactively with the customer and the system.

Again returning to block 210, another process can be used to select images, if the customer device has read/write capabilities. This device can be used to store data instead of transmitting the data to the processor 16 during the customers travels through the site 12.

In this embodiment, the customer 11 selects an image type as above in blocks 211-217 (block 260). An image identifier and the selected image type are then stored in a folder on the device (block 261).

The viewing and selection processes can be repeated until the customers visit is complete (block 218), at which time s/he can proceed to the viewing/sales area 30 (block 219) if desired. Using the device, the customers folder 18 is accessed, whether from the processor 16 or the device (block 220). Either the stored information or facial recognition software can be used to access all photographs having been taken that include or relate to the customer 11 (block 221). A benefit of having used multiple people in the customer image is that additional faces can aid in increasing the probability that the correct customer has been identified by a significant degree. For example, at present facial recognition may have a certain range of accuracy, whereas the addition of other data, such as other faces, clothing color, etc., can bring the probability close to 100%.

Each image and order in the folder 18 is processed according to type (block 222). An image containing a customer 11 is retrieved from the folder 18 (block 223), and a “stock” image without the customer 11 is retrieved from the database 31 (block 224). For those images wherein the customer 11 wishes to be inserted (block 225), the associated “stock” image is retrieved from the database 31, and the customers image, as taken in step 208, is inserted thereinto digitally using techniques known in the art such as background replacement or compositing (block 226).

The customer 11 can also have the option to have the souvenir 13 enhanced with material stored in the database 31, such as age-appropriate informational textual material and/or additional images (block 227). For example, in a museum, didactic material relating to a particular objet d'art could be inserted.

Once the image collection is complete, the software 17 can be used to begin to create the customer's “album.” If the album is to be a physical object, there will typically be size limitations. The software 17 has a module for creating album pages automatically (block 228), making determinations as to page layout and relative size of images, for example. The software 17 can also select a layout and graphics based upon the customer's age. A complete “album” can then be digitally created (block 229), and the customer 11 can preview the album on a display 37, or on the customer device such as smart phone, and request revisions as desired, which can be entered via an input device 38 (block 230). The “album” can be in any form known in the art. If a DVD-type souvenir or a souvenir in some other format of digital recording is selected, stock video clips could form part of the souvenir 13.

If the souvenir 13 had not been purchased at the start of the visit (block 231), and if the customer 11 wishes to purchase the souvenir 13 (block 232), payment is arranged and received (block 233).

The final souvenir 13 is then delivered to the customer 11 in one or more forms known in the art (block 129).

In addition to, or instead of, a physical souvenir 13, an online option can be selected (block 235). If so, the customer data are cataloged (block 236). The images selected are correlated to determine the customer's interests (block 237). Then a person website 40 can be created for the customer 11 (block 238), which can be updated periodically with continuing age-and interest-specific educational and informational materials (block 239), and is accessible over the internet 41.

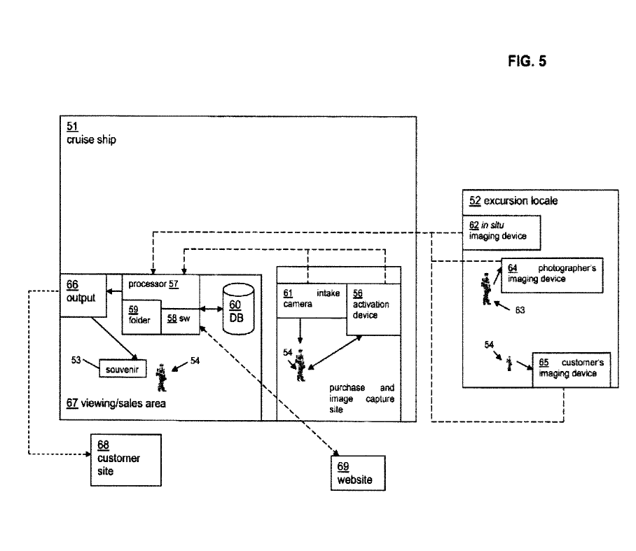

A system 70 (FIG. 5) and method 300 for use in a defined time period operates similarly to the system 10 and method 100 discussed above, with common reference numerals referring to analogous elements.

The system 70 and method 300 are preferably for use in a defined time period within one or more or sites, such as, but not intended to be limited to, a cruise ship 51 or other touring vehicle used as a base of operations and at least one side excursion site, such as a locale 52 visited as a day trip from a cruise ship 51, or any such sites known in the art. Herein the system and method will be discussed in terms of a cruise ship with side excursions, but this is not intended as a limitation, and is only used for ease of discussion.

The system 70 and method 300 provide a customer with a pictorial souvenir 53 of a vacation/tour. It will be understood by one of skill in the art that the words picture, image, camera, and photograph are not intended to be limited to a particular construction, and that still and moving images and recording devices can be contemplated thereby, and may include other media such as sound.

In a particular embodiment, a potential customer 54 enters a cruise ship 51 that has been outfitted with components for creating a pictorial memento 53 of the vacation (block 301). The opportunity to purchase this souvenir 53 can be offered to the customer 54 upon entering the ship 51, for example, at a pre-visit purchase and image capture site 55, an offer that can be accepted (block 302) or rejected (block 303) by the customer 54. In either case, the customer 54 can be given an encoded activation device 56 (block 304), which can comprise, for example, a key card with a readable magnetic stripe or other storage medium such as known in the art. This device can also comprise the customer's cell phone or a remote control device, or any other such device capable of transmitting a signal such as known in the art. The transaction related to establishing a customer ID and a link to the system's computerized central facility can be wholly electronic, such as by communications between a customer device such as a smart phone, tablet or personal computer and the system's central facility over the Internet or over a cell telephone system.

A protocol is established for communication between the activation device 56 and a processor 57, which has software 58 for creating a folder 59 specific to the customer 54 (block 305), which is storable on a database 60 in signal communication with the processor 57. In one embodiment, an initial image of the customer 54 can be captured by an intake camera 61 and stored in the folder 59 (block 306), for example, using “green screen” technology so that the customer's image can be embedded subsequently in other images if desired.

On the cruise ship, the customer 54 may desire to capture an image of and/or with an object (block 307) or other people, such as a dining group. There are several ways in which this may be accomplished, as discussed above, and these options will not be repeated here. Suffice it to say that images of the types previously described above with reference to blocks 109,112,114 (FIG. 2A) can be collected and stored in the customer's folder 59.

If the customer 54 travels off the cruise ship 51 to a shore excursion locale 52, analogous opportunities exist for images to be collected (block 308), whether via an automated process with an in situ imaging device 62 or a human photographer 63 operating an imaging device 64. Images can also be taken by an imaging device 65, preferably digital, operated and/or owned by the customer 54. The customer's imaging device 65 can comprise any device known in the art, such as, but not intended to be limited to, a still camera, a video camera, and a cellular telephone having a camera associated therewith. If the customer's imaging device 65 has the capability, one or more of these collected images can be transmitted to the processor 57 for incorporation into his/her folder 59.

When the customer desires to complete a trip souvenir 53, which typically occurs at or near the end of the trip (block 309), s/he can proceed to a viewing/sales area 66 (block 310) if desired. Using the activation device 56, the customer's folder 59 is accessed (block 311). If the customer 54 wishes to augment the folder 59 with images from his/her own imaging device 65 (block 312), a transfer of such images can be made (block 313). The images are then processed as outlined above (block 314). One of skill in the art will appreciate that the customer 54 does not necessarily need to go to a physical location, and that these steps can be completed via computer or smart phone from any location on the ship, or even elsewhere, so long as connectivity is achieved.

Also as above, the customer 54 can have the option to have the souvenir 53 enhanced with material stored in the database 60, such as informational textual material and/or additional images (block 315). For example didactic material relating to a particular locale 52 that was visited, or historical information on the ship 51 could be inserted in the customer folder. A complete “album” can then be digitally created (block 316), and the customer 54 can preview the album on an output device 67 or a customer device such as smart phone and request revisions as desired (block 317).

If the souvenir 53 had not been purchased at the start of the visit (block 318), and if the customer 54 wishes to purchase the souvenir 53 (block 319), payment is arranged and received (block 320).

The final souvenir 53 is then delivered to the customer 54 in one or more forms as discussed above (block 321). For example, the souvenir 53 can take the form of a physical, printed album, which could be printed and bound on site. Alternatively, the souvenir 53 can take the form of a digital record, for example, stored on media. Further, the souvenir 53 can take the form of a digital record transmitted to the customer 54 at a desired site or device 68. Additionally, the souvenir 53 can be presented on a website 69 created for the customer 54 in connection with the trip. The digital media and record can contain both still and moving images and sound as desired.

The final souvenir 53 can comprise multiple forms and components as desired. Further, as above, some of the cost of producing the souvenir 53 can be defrayed by including advertising.

The many advantages offered by the systems 10,50,70 and methods 100,200,300 will be understood by one of skill in the art. The customer 11,54 receives a professionally imaged and assembled souvenir 13,53 containing images typically not possible or practical to be achieved by the customer 11,54 him/herself, whether owing to perspective, vantage point, or quality, and retain all the pleasures of the visit without having to take photographs him/herself. Professional photographers are not required, since the cameras will have been set to take an optimal image, and all else is automated. “Stock” images will have been taken and stored under ideal conditions of lighting and vantage point, thereby minimizing the chance of causing damage to the objects by excess light.

Additionally, the interactivity of the systems 10,50,70 and methods 100,200,300 enable data to be collected on customers 11,54 as to their preferences individually and collectively, which can be used to inform subsequent marketing and display strategies (block 240), including providing suggestions to the customer 11,54 as to other attractions that might be of interest, based upon the customer's stored preferences.

In the case of some venues such as, without limitation, sports arenas, theme parks and museums, a customer's smart phone or tablet can be particularly useful as the activation device. For example, the phone can be provided with an application that establishes a communication link with a central computer that also communicates with automated cameras that are at selected locations in the venue and is configured through appropriate programming to operate the entire system. The customer can be offered such an application for downloading into the customer's phone or tablet, of an already configured phone or tablet can be loaned to the customer. The customer's phone or tablet can be provided with an icon that, when clicked or tapped, serves to indicate to the central computer to instruct an automated camera pointed to the current location of the customer, or to a location that the customer would like to have imaged for potential inclusion in the customer album, to take one or more images. The central computer can transmit the customer's album to the customer's phone or tablet at times selected by the customer or the system, so that the customer can view the album as it is being built and can edit the album by deleting images or other material or re-arranging images and other material, thus providing immediacy that is believed to encourage customers to have more images taken and to purchase an album. The customer's locations can be tracked automatically, for example through the use of the GPS capability embedded in the phone or tablet. The album may be delivered to the customer's phone or table via WiFi or some other electronic link, so that the customer need not take time to stop and pick up a hard copy of the album. In addition, after any editing the customer's album can become a book-like product that is printed at the venue or at another location. The customer's phone or tablet can further provide an audio input that is transmitted to the central computer to be merged with images in the customer's folder, for example to provide audio captions to the images.

As another example, the activation device can trigger the automated image taking by being present at a specified location. For example, ski resorts, Marathon or parade routes, or other venues can be provided with sensors to detect the proximity of a device carried by the customer, such as an RF tag. The tags are associated with respective customers, so that an image of the customer is automatically taken when the customer is at the sensed locations and is added to the customer's album.

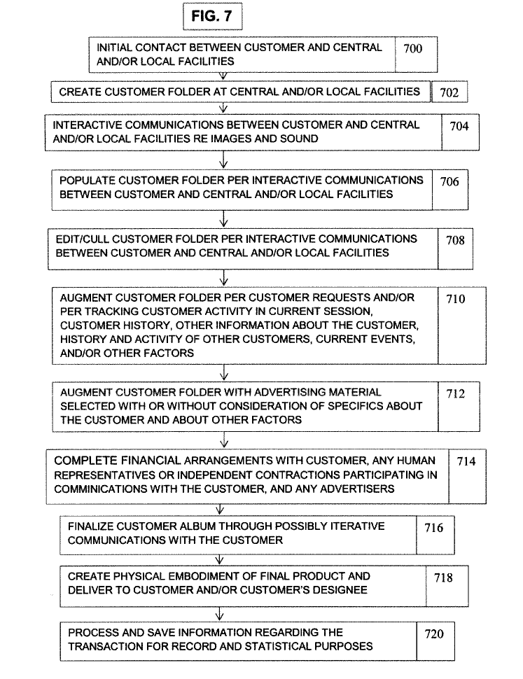

FIG. 7 illustrates steps that can be included in examples of the systems and method described in this patent specification. Depending on the particular implementation details, the steps need not be performed in the indicated order, and not all steps may be needed. In step 700 a customer establishes initial contact with the central systems, which contact may be direct, or it may involve contact with a human representative or an independent contractor serving as an intermediary between the customer and the central facility for some of the operations to follow. If the contact is directly with the central facility, it can be in any one or more of the ways referred to above. For example, the customer can contact the central facility from a device such as a smart phone or from another electronic device that the customer owns or the system provides to the customer or to which the system affords access by the customer for the purpose of a session that would create a customized album for that customer. In the example of a dedicated imaging facility, a museum, a library, and the like, the contact can be through touch screens or other interface devices that are built in and the customer can operate. If the contact involves a human representative, the representative can identify the customer for the session to follow in any one or more ways such as giving the customer a uniquely identified item such as a card with unique indicia, taking an initial picture of the customer and/or the card, key-in identifying information about the customer in an electronic device that the representative carries, etc. The representative can transmit the customer identification to the central facility immediately or later, at any time throughout the session in which the customer is involved. The result of step 700 typically is a link between the customer and one or more folders, or potential folders, for images of or relating to the customer and other information about the customer. This link can be directly with the central facility or can be initially only with equipment that the human representative carries or controls. In some embodiments this initial contact can take place after some or all images of or relating to the customer have been taken, as in the examples of imaging a venue or an event such as a sports facility or a sports event and later offering potential customers an opportunity to select images or portions of images for a customized album. The customer identity can include additional information about the customer such as the customer location, e.g., the customers seat in a sports arena, or the customer initial and/or updated location, for example by using an electronic device that affords location tracking or using face recognition.

Step 702 creates one or more customer folders at the central facility and/or the local facility. The central facility can be one or more computer facilities that need not be all in the same place so long as the requisite communication paths with the customer and any human representative and advertisers can be established and maintained as needed for the remainder of the session involving the customer. The customer folder can reside in one or more locations in computer memory that can be identified as linked with that customer. If a human representative is involved, the customer folders can reside for some time only at equipment carried or controlled by the representative. For a venue such as at a museum or a theme park, the entire central facility can be at that location, or some can be at a remote location, and there can be an additional central facility that duplicates and/or supervises/controls at least some of the computer operations of the local venue. In some embodiments, the creation of customer folders can take place at a later stage, for example when participants in a sports event such a foot race can view race images and decide to become customers who can select already taken images for inclusion in customized albums.

Step 704 involves interactive communications between customers and the system. Where the communications do not involve human intermediaries, they can be through devices such as a customer's smart phone, an electronic device lent to the customer for the session, a built-in device such as keyboards or touch panel or buttons at the venue, the customer's presence at specified locations in the venue, hand gestures by the customer, etc. These communications can involve requests or assents by the customer about where and when to have images taken and/or sound recorded and what the images and sound should cover, and any information that the system may convey to the customer such as where to have images taken or sound recorded, etc. In embodiments where human representatives are involved, some or all of these communications can be by speech or gestures.

Step 706 involves the population of the customer folder or folders with images and any sounds. In the example of a venue such as a museum, a customer can stand near a painting or stature and request an image by operating a cell phone or other device to request an image and then to start a count-down for taking an image, and the system responds by operating an automated camera and possibly automated lighting as needed to take one or more images of the customer or the customer group and by storing the images and any related sound in the customer folder. The system may send proofs of the taken images to the customer device or to some other device to which the customer has access, and the customer can send back to the system information such as a request to re-take images or to delete images or to keep images. In an example such as a sports arena in which a game is on, the communications can involve actively sent or passively acquired information about the customer moving from one location to another, such as a smart phone message by the customer that he or she has changes seats, or location tracking of the customer through GPS or some other similar system or face recognition tracking of the customer. When a human representative is involved, the communications can be by personal contact in addition to or instead of the types of electronic contact discussed above. For any given customer and session with the system, these communications can be continuous, or intermittent, and in some cases can be fully automated so no purposeful action by the customer would be required. The result of step 706 is a customer folder that is populated with images and possibly sounds that can be further processed for create a customized album for that customer.

Step 708 involves further processing of the contents of the customer folder. The system can send to the customer proofs of some or all of the images in the customer folder, so that the customer can request editing such as cropping or other changes, or can request deletion of some images. Some or all of such editing/culling can be done by the customer, for example on a customer devices such as a smart phone or on equipment at the site to which the customer has access, such as a touch screen that displays images to the customer and instructs the customer how to edit or delete images. If a human representative is involved, equipment carried by or available to the human representative can be used for that purpose, with the human representative assisting the customer as needed for editing or culling of images. Similar interactive processing can be done at any time during the session, from the first time images of or for the customer are taken or sound recorded, to the time just before the customer album is delivered to or for the customer, but typically would take place after the customer folder is fully populated with images and sound for the album.

In step 710, the system can augment the customer folder with additional images, sounds, and other material. This can be done partly or entirely at the customer request and direction, or partly or entirely based on determination the central and/or local system facilities and/or any human representative or advertiser makes, or can be based on a combination of decisions by some or all the persons and entities that are involved. The augmenting material can be separate from the images taken of or for the customer, or it can be blended with such images, for example by compositing images taken of or for the customer with other images, and similar blending can be done for sound. In the example of an album that memorializes a customer's museum visit, the customer images can be augmented by adding stock images of art that the customer has seen and perhaps has viewed for longer time intervals, text about the artist or the historical context, music that might be relevant to the artist or period, suggestions for future visits, advertising material, etc. In the example of a visit to a ball game, the customer folder can be augmented with material such images of the ball park, of significant moments in the game, with information regarding teams, players, statistics, etc. In the example of park or zoo visits, the customer folder can be augmented with images of park or zoo features, or animals, etc. Some or all of this material can be selected for addition to the folder by the customer. For example, using a smart phone or other communication device the customer can request an image of some feature or activity at the venue that may or may not include the customer, and the system can respond by operating automated equipment to take the images or record the sound, or can retrieve stock images for addition to the customer's folder. Alternatively or in addition, the programmed computer equipment of the central and/or local facilities can select material for addition to the customer folder, using for the purpose algorithms that take into account information from or about the customer, e.g., that the customer lingered long when viewing a painting, or take into account a profile of the customer that the system has created. For example, the profile may suggest that the customer is likely to favor a sports team or player, or that customers in the venue have been highly interested in an image of a particular feature, e.g., an air view of a ball park, or that a particular play that just took place is memorable and an image related to it is likely to be of interest, and/or any or a number or other factors that may make it likely that the customer will be interested in such material. As mentioned, some or all of the material can be composited with images or sound of or for the customer. For example, the central/local facility computer equipment can composite an image of the customer into an image of a ball team.

In step 712, the system can augment the customer folder with advertising material, for which the system can receive compensation from advertisers. The advertising material inserted in the customer folder can be selected for the particular customer, for example in the way Google or Amazon select advertising material based on customer behavior, or it can be selected without regard for the customers likely interests and preferences. For example, advertising material for a business or an event can be added to the folder for each customer at a venue at a given time frame.

In step 714 financial arrangement are completed with the customer and any human representatives, independent contractors, or advertisers based on factors such as the current state of the customer folder, or after it has been edited, culled and augmented as discussed above. The operations involved in this step can be distributed in time in that some can take place before and/or during the taking of images and recording of sound, some or all may make place during or after the editing and culling of the customer folder, and some or all may take place at a time related to the finalization of the customer album and/or the delivery of the album to or for the customer. The specific details of this step depend on the details of the implementation that a particular system operation has selected, and can use algorithms similar to those employed by providers of goods or services over the Internet, e.g., Amazon or Apple.

Step 716 involves finalizing the customer album. It can include interactive communication with the customer, for example, showing a preview version to the customer on a customer device or a device made available to the customer so that the customer can respond with requests for changes such as re-arranging or dropping images or sound, or this step can be carried out by the system without direct input from the customer, using known or customized technology for assembling images and other material into an album, similar to those used to assemble material for a magazine or newspaper and create layouts.

Step 718 pertains to creating a physical embodiment of the customer album and its delivery to or for the customer. The physical embodiment can be a printed album, using printing facilities at the venue, such as higher quality color printers and binders, so that the album can be handed over to the customer immediately. Instead or in addition, the album can be printed at a remote facility that the customer or the system operates or designates, for example a print shop convenient to the customer or a print facility that can mail or otherwise deliver an album to a person or address that the customer designates. And, instead or in addition, the physical embodiment can be an electronic version of the album that the system can deliver electronically to the customer's device or facility such as a smart phone, a tablet, a personal computer, a web site, etc., and/or the album can be embodied in a physical medium such as an optical disc, a flash drive, or a similar product that can be handed to or otherwise delivered to the customer or the customer's designee.

Step 720 can take place at any time, for example during or after the performance of the other steps, and involves processing and saving information regarding the transaction with the customer, including the image taking and editing/culling session, any sound recording, and any other information regarding the customer that has become available to the system. This information can be used to create and save a customer profile or format to be used in a future encounter with the customer or to direct informational and advertising material to the customer, and for statistical purposes to create a database that can be used to enhance the systems and methods discussed above.

In the foregoing description, certain terms have been used for brevity, clarity, and understanding, but no unnecessary limitations are to be implied therefrom beyond the requirements of the prior art, because such words are used for description purposes herein and are intended to be broadly construed. The terms central facility and central computerized facility have been used in a broad sense, to encompass a distributed facility that may include or be implemented in a dedicated computer, plural computers, and equipment carried by a human representative or located at a specific venue.

Moreover, the embodiments of the systems illustrated and described herein are by way of example, and the scope of the invention is not limited to the exact details of construction and use. Components and features described in one embodiment can be used instead of or in addition to components and features described in the context of other embodiments.

1. A method of creating a customized pictorial souvenir of a customer's visit at a venue or participation in an event, comprising:
initiating contact between the customer and a computerized central facility and linking a customer identification with a folder for the customer;
interactively communicating among the customer, the computerized central facility and camera equipment to take images of or for the customer at selected locations and times associated with at least one of the venue or event, and populating the customer folder with at least some of said images;
further interactively communicating at least between the customer and the central facility to select or de-select images from the customer's folder and to edit images in the customer's folder;
selectively augmenting the contents of the customer's folder with additional material selected for relationship at least with the customer's communications with the central facility;
creating a customized album for the customer related to the contents of the customer's folder;
completing financial arrangements with the customer and any other involved party;
creating one or more embodiments of a customized pictorial souvenir for the customer related to said customized album; and
delivering the one or more customized embodiments to at least one of the customer and a customer designee.

2. The method of claim 1 further including populating the customer folder with sound selected by or for the customer, and including sound based thereon in a version of said customized album

3. The method of claim 1 in which the step of initiating contact is carried out through an electronic link between the customer and the central facility.

4. The method of claim 3 in which the electronic link is wireless.

5. The method of claim 1 in which the step of selecting a de-selecting images comprises presenting the customer with proof images from the customer folder.’

6. The method of claim 5 further including taking measures to preclude use of the proof images for purposes other than selecting and de-selecting images from the customer folder.

7. The method of claim 1 in which the step of augmenting the customer's folder comprises adding images that do not include the customer.

8. The method of claim 1 in which the step of augmenting the customer's folder comprises adding text for inclusion into the customized folder.

9. The method of claim 1 in which the step of augmenting the customer's folder comprises adding composited images that include the customer and images of other scenes.

10. The method of claim 1 in which the step of communicating to take images comprises electronically tracking the customer's location and taking images at sites that are selected in relation to the electronic tracking.
